(19) United States
(12) Patent Application Publication
(10) Pub. No.: US 2024/0104531 A1
(43) Pub. Date: Mar. 28, 2024

(54) SYSTEMS AND METHODS FOR GENERATING A CODE TO TOKENIZE FUNDS

(71) Applicant: Wells Fargo Bank, N.A., San Francisco, CA (US)

(72) Inventors: Darren M. Goetz, Salinas, CA (US); Dennis E. Montenegro, Concord, CA (US); Alicia Y. Moore, San Ramon, CA (US); Timothy R. Ward, Mesa, AZ (US)

(21) Appl. No.: 16/539,721

(22) Filed: Aug. 13, 2019

(51) Int. Cl. G06Q 20/10; G06Q 20/32; G06Q 20/36

(52) U.S. Cl. CPC G06Q 20/105; G06Q 20/1085; G06Q 20/3274; G06Q 20/3672

(57) ABSTRACT

Systems, methods, and apparatuses for generating a tokenized cash code include a provider computing system associated with a provider including a network interface structured to facilitate data communication via a network and a processing circuit comprising a processor and memory. The processing circuit is structured to receive a signal from an external device indicating a monetary amount. The memory comprises a tokenize cash code circuit structured to generate a tokenized cash code associated with the monetary amount and structured for a redemption of the monetary amount at an ATM. The processing circuit is structured to transmit the tokenized cash code to a user of the external device.

### TECHNICAL FIELD Embodiments of the present disclosure relate generally to the field of tokenized funds.

### BACKGROUND

Many transactions are completed each day at various retailers. These transactions may include an exchange of cash from a retailer patron to the retailer in exchange for goods or services provided by the retailer. Accordingly, as a patron pays with cash, it is customary for the retailer to dispense change due to the patron in the form of cash. However, due to the dispensing of change to retailer patrons, point-of-sale (POS) terminals and the like may need to be frequently restocked with cash to dispense as change to patrons. Restocking of cash can be difficult or undesirable by the retailer due to circumstances such as a constant use of POS terminals by patrons and security of retailer employees restocking cash.

### SUMMARY

A first example embodiment relates to provider computing system associated with a provider. The provider computing system includes a network interface structured to facilitate data communication via a network and a processing circuit comprising a processor and memory. The processing circuit is structured to receive a signal from an external device indicating a monetary amount. The memory includes a tokenized cash code circuit structured to generate a tokenized cash code (TKC) associated with the monetary amount. The TKC is associated with the monetary amount and is structured for redemption of the monetary amount at an ATM. The processing circuit is structured to transmit the TKC to a user of the external device. In various embodiments, the processing circuit transmits the TKC to the user on a printed receipt and/or a user device associated with the user.

In various embodiments, the TKC is valid for a predetermined time period and/or includes a security authenticator associated with the user of the external device. In some embodiments, the TKC is in the form of a QR code or a barcode. Additionally, the TKC can be transmitted as a printable image that is presented to the user on a printed receipt.

In various embodiments, the external device includes a retailer point of sale terminal structured to interpret the TKC for a redemption of the monetary amount associated with the TKC. A reward bonus can be added to the monetary amount for the redemption of the TKC with an owner of the external device.

Another example embodiment relates to a computer-implemented method. The method includes receiving, by a provider computing system, a signal from an external device indicating a monetary amount, generating a TKC associated with the monetary amount, transmitting the TKC to a user of the external device, receiving a redemption request signal indicating a request to redeem the TKC, verifying a validity of the TKC, and transmitting an approval signal allowing for redemption of the TKC.

In various embodiments, the method includes generating a valid time period associated with the TKC defining a time period for which the TKC can be redeemed and/or a security authenticator associated with the TKC structured to authenticate the user of the external device.

In various embodiments, transmitting the TKC to the user of the external device involves transmitting the TKC to a user device associated with the user of the external device. Transmitting the tokenized cash may also, or alternatively include transmitting the TKC to a retailer point of sale terminal. In such embodiments, the method further involves printing, by the retailer point of sale terminal, a receipt with the TKC printed on the receipt.

In some arrangements, generating the TKC associated with the monetary amount involves adding a reward bonus to the monetary amount for a redemption of the TKC with an owner of the external device.

Another example embodiment relates to an automated teller machine (ATM). The ATM includes a network interface structured to facilitate data communication via a network and a processing circuit comprising a processor and memory. The memory includes an input/output (IO) circuit structured to receive an input comprising a TKC and a TKC interpreter circuit structured to interpret the TKC to determine the monetary amount associated with the TKC. The ATM also includes a cash dispenser structured to dispense the monetary amount associated with the TKC.

In various embodiments, the TKC circuit is structured to generate the TKC valid for a predetermined time period and/or a security authenticator associated with the user of the external device.

The processing circuit may be to transmit the TKC to the user of the external device, whereby the TKC may be transmitted to the user on a printed receipt. In various embodiments, the processing circuit is configured to transmit the TKC to the user of the external device via a user device of the user.

In some arrangements, the external device includes a retailer point of sale terminal structured to interpret the TKC for a redemption of the monetary amount associated with the TKC. Further, a reward bonus may be added to the monetary amount for the redemption of the TKC with an owner of the external device.

These and other features, together with the organization and manner of operation thereof, will become apparent from the following detailed description when taken in conjunction with the accompanying drawings.

### BRIEF DESCRIPTION OF THE FIGURES

FIG. 1 is a block diagram depicting an example environment for requesting, providing, and redeeming TKCs, according to an example embody embodiment.

FIG. 2 a flowchart depicting a method for generating and verifying a TKC, according to an example embodiment.

FIG. 3 is a schematic drawing depicting an example user interface of the retailer computing system used in the environment of FIG. 1, according to an example embodiment.

FIG. 4 is a schematic drawing depicting a mode of TKC transmission used by the retailer computing system, according to an example embodiment.

FIG. 5 is a schematic drawing depicting an example user interface of the user device used in the environment of FIG. 1, according to an example embodiment.

FIG. 6 is a schematic drawing depicting another example user interface of the user device used in the environment of FIG. 1, according to an example embodiment.

FIG. 7 is a schematic drawing depicting another example user interface of the user device used in the environment of FIG. 1, according to an example embodiment.

FIG. 8 is a schematic drawing depicting an example user interface of the ATM used in the environment of FIG. 1, according to an example embodiment.

### DETAILED DESCRIPTION

Referring to the FIGURES generally, various systems, apparatuses, and methods of generating tokenized codes associated with a monetary amount are described herein. In lieu of transferring an amount of cash between a funds transferor and a funds receiver, a tokenized cash code (TKC) can be generated by which the amount of cash can be represented. The system described herein generates the TKC associated with the funds, which the funds receiver receives and can use to redeem for the funds. As used herein, the term “tokenized cash code” or “TKC” refers to a generated identifier of an amount of cash that can be redeemed for the corresponding amount of cash. A TKC can include various security measures (e.g., user authorization, account verification) applied to the TKC which are used to verify the credentials of the funds receiver and/or the validity of the TKC. For example, in order to redeem the amount of funds associated with a TKC, a funds receiver is required to enter a PIN associated with a financial account of the funds receiver. Further, the validity of the TKC entered by the funds receiver is verified by searching, in a database storing generated and confirmed TKCs, for a generated TKC that matches the TKC entered by the funds receiver. Accordingly, the TKC may be any type of code (e.g., a one-time passcode, an alphanumeric code, a QR code, a barcode) which can be interpreted or de-coded for redemption of the associated amount of funds.

Various exemplary implementations of generating a TKC provide solutions for transferring of funds without the need to dispense or otherwise transfer physical cash. In one implementation, a retailer (e.g., a supermarket, a clothing store, a book store) issues a change TKC representative of change due for a transaction completed by a customer using cash as a method of payment. In another implementation, a retailer (e.g., restaurant, a café, a diner) issues a tip TKC to an employee (e.g., a server, a busboy, a host, etc.) representative of tips allocated to the employee by patrons of the retailer. In yet another implementation, a funds transfer TKC is generated and transmitted to a funds designee (e.g., an individual who is designated to receive an amount of cash) from a funds transferor (e.g., an individual who wishes to transfer funds to the funds designee) in lieu of exchanging physical cash from the funds transferor to the funds designee. The various types of TKCs may be redeemed in a variety of methods including redemption of the funds associated with the TKC for cash at an ATM, redemption of the funds associated with the TKC at a retailer as payment for goods or services provided by the retailer, and redemption of the funds associated with the TKC by transferring the funds into an account (e.g., a financial account associated with a financial institution, a shopper's account associated with a retailer). In scenarios in which the funds associated with a TKC are redeemed at an ATM and/or scenarios in which the funds associated with the TKC are redeemed at a retailer (e.g., a retailer location, a retailer website, a retailer mobile application), the funds designee does not need to have an account associated with the provider of provider computing system that generates and transmits the TKC. The ability for a funds designee to redeem a TKC without the need to have an account with the provider that issues the TKC allows the systems and methods described herein to be extended for use by a greater group of funds designee (rather than just clients of the provider who issues the TKCs).

Advantageously, the systems and methods described herein solve the complexities of distributing, counting, and/or otherwise transferring an amount of cash between a funds transferor and funds designee by providing a TKC representative of the amount of cash. For example, a retailer tasked with issuing cash change can avoid the need to restock cash in multiple POS terminals and reduce the need to count cash in such POS terminals thereby freeing personnel to complete other tasks and/or requiring fewer visits by cash suppliers. Further, the implementation of a TKC generation system as described herein helps simplify the process of maintaining checks and balances of a retailer or other funds transferor by providing a computerized tracking system of funds transferred, distributed, or otherwise issued.

As used herein, the term “funds transferor” is defined as an individual or entity that transfers an amount of funds to a funds designee. Accordingly, as used herein the term “funds designee” is defined as an individual or entity that is designated to receive an amount of funds from a funds transferor.

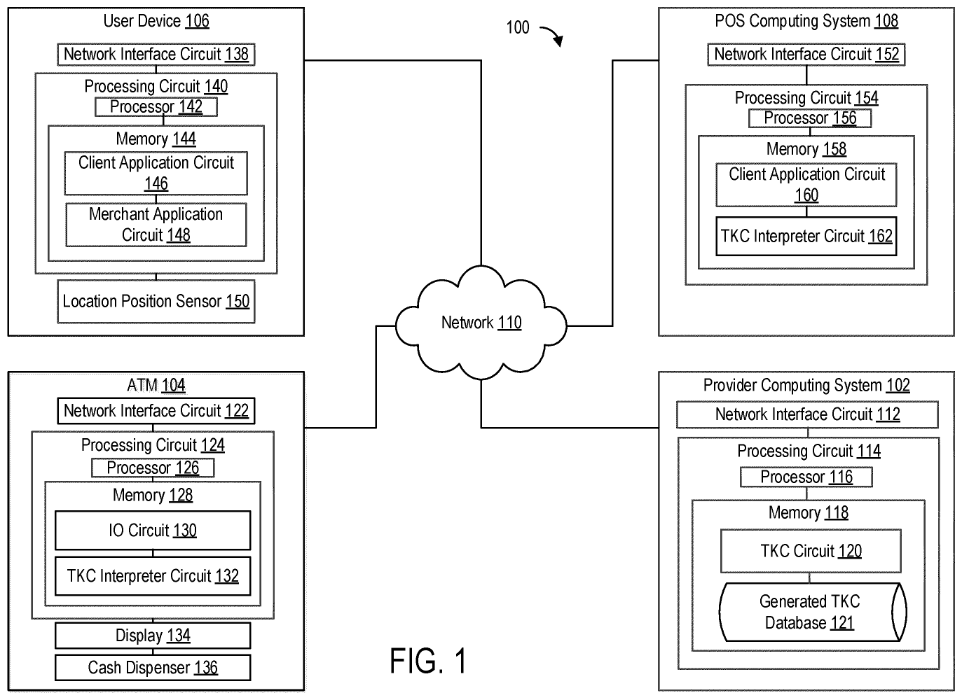

Referring to FIG. 1, a block diagram of a cash tokenization system 100 is shown, according to an example embodiment. As described in further detail below, the system 100 facilitates the generation, transfer, and redemption of a TKC associated with a predetermined amount of cash. As shown, the system 100 includes a provider computing system 102 communicably and operatively coupled with an ATM 104, a user device 106, and a POS computing system 108 over a network 110. The network 110 provides communicable and operative coupling between the ATM 104, user device 106, and POS computing system 108, and other components disclosed and described herein to provide and facilitate the exchange of communications (e.g., data, instructions, messages, values, commands). Accordingly, the network 110 may include any network including wired (e.g., Ethernet) and/or wireless networks (e.g., 802.11X, ZigBee, Bluetooth, WiFi). In some arrangements, the network 110 includes the Internet. In further embodiments, the network 110 includes a proprietary banking network to provide secure or substantially secure communications.

The provider computing system 102 is operated by a provider, which is an entity that facilitates various types of transactions between the ATM 104, user device 106, POS computing system 108, and various other entities not explicitly described or shown herein. The provider may be a bank, credit union, a payment services company, or other similar entities. The provider computing system 102 includes, among other systems, a network interface circuit 112 enabling the provider computing system 102 to exchange data over network 110 and a processing circuit 114.

The network interface circuit 112 includes program logic that facilitates connection of the provider computing system 102 to the network 110. The network interface circuit 112 supports communication between the provider computing system 102 and other systems, such as the ATM 104, user device 106, and the POS computing system 108. For example, the network interface circuit 112 includes a cellular modem, a Bluetooth transceiver, a Bluetooth beacon, a radio-frequency identification (RFID) transceiver, and a near-field communication (NFC) transmitter. In some embodiments, the network interface circuit 112 communicates via a secure wired connection within a branch of a provider (e.g., a financial institution) associated with the provider computing system 102. In some arrangements, the network interface circuit 112 includes the hardware and machine-readable media sufficient to support communication over multiple channels of data communication. Further, in some arrangements, the network interface circuit 112 includes cryptography capabilities to establish a secure or relatively secure communication session with the provider computing system 102, ATM 104, user device 106, and POS computing system 108. In this regard, financial data (or other types of data) may be encrypted and transmitted to prevent or substantially prevent the threat of hacking.

The processing circuit 114 includes a processor 116 and memory 118. The processor 116 may be implemented as one or more application specific integrated circuits (ASICs), field programmable gate arrays (FPGAs), a group of processing components, or other suitable electronic processing components. Memory 118 may be one or more devices (e.g., RAM, ROM, Flash memory, hard disk storage) for storing data and/or computer code for completing and/or facilitating the various processes described herein. Memory 118 may be or include non-transient volatile memory, non-volatile memory, and non-transitory computer storage media. Memory 118 may include database components, object code components, script components, or any other type of information structure for supporting the various activities and information structures described herein. Memory 118 may be communicably coupled to the processor 116 and include computer code or instructions for executing one or more processes described herein.

The provider computing system 102 includes a TKC circuit 120 structured to manage, generate, transmit, and verify tokenized codes associated with a cash value. Accordingly, the TKC circuit 120 is communicatively coupled to the ATM 104, user device 106, and the POS computing system 108. The TKC circuit 120 is structured to receive a request to generate a TKC associated with an amount of funds from a funds transferor and transmit the TKC to a funds designee (e.g., via user device 106, POS computing system 108) to be redeemed by the funds designee. As will be described in greater detail below, the TKC circuit 120 receives a signal indicating a transaction (e.g., from POS computing system 108), generates a TKC associated with the transaction, and transmits the TKC to the user device 106 for use by the user. In some arrangements, the TKC circuit 120 is structured to generate a TKC with security authorization measures (e.g., a PIN, facial recognition, biometrics). For example, the TKC circuit 120 generates a TKC with a PIN associated with the TKC. As such, the TKC circuit 120 requires the funds designee to input a PIN such that the PIN must be entered when the TKC is redeemed.

Advantageously, the TKC generated by the TKC circuit 120 avoids the need for a funds transferor (e.g., a retailer associated with the POS computing system 108) to distribute cash to a funds designee by tokenizing the cash amount with the TKC for redemption (e.g., at ATM 104, transferring to account held by the funds designee) by the funds designee. In some arrangements, the TKC is associated with an amount of change due based on a cash transaction completed at a retailer such as a supermarket, convenience store, restaurant, and the like. For example, in lieu of dispensing change to a customer at a point-of-sale terminal associated with POS computing system 108, the POS computing system 108 requests a TKC from the provider computing system 102 such that the customer involved with the terminal can then use the TKC to redeem the amount of change at an ATM (e.g., ATM 104). In various embodiments, the TKC circuit 120 imposes a time limit on a generated TKC. In such embodiments, the time limit defines an amount of time that the generated TKC is eligible for redemption. For example, the TKC circuit 120 generates a TKC with a time limit of one month. As such, the funds designee who receives the TKC has one month to redeem the TKC (e.g., the TKC becomes invalid after one month) for the amount of money associated with the TKC. In cases where the TKC is not redeemed by the funds designee before the TKC expiration defined by the time limit, the funds associated with the TKC are returned to a financial account of the funds transferor. In some embodiments, the TKC circuit 120 generated and transmits a reminder to user (e.g., via user device 106) to redeem the TKC for cash at the ATM 104. The reminder may be sent a time period prior to the TKC expiration. For example, a reminder to use/redeem the TKC is transmitted at least 24 hours before the expiration of the TKC.

In various embodiments, the time limit imposed on a generated TKC is dependent on the amount of funds associated with a TKC and/or the type of TKC generated (e.g., a mobile code transmitted to a phone, a printed receipt with an image of the TKC printed thereon, redemption of TKC for cash, etc.). In some embodiments, the higher the amount of funds associated with a TKC, the shorter the time limit is to redeem the TKC. As such, with a high amount of funds (as can be defined by the retailer of provider), the higher the risk the TKC has due to the funds designee potentially losing the TKC. In some embodiments, the length of time imposed on a TKC is dependent upon the type of TKC generated. For example, a retailer may offer a longer time to live on a TKC if the funds designee selects to be able to redeem the code for purchasing items at the retailer.

The provider computing system 102 is also shown to include a generated TKC database 121. In various arrangements, the generated TKC database 121 is configured to retrievably store each TKC generated by the TKC circuit 120. Accordingly, the generated TKC database 121 is communicably and operatively coupled to the TKC circuit 120. In some embodiments, the generated TKC database 121 is configured to store redeemed TKCs (e.g., TKCs who have been redeemed for the associated amount of cash). In some such embodiments, the TKC circuit 120 looks to the redeemed and/or generated TKCs stored in the generated TKC database to ensure that the TKC circuit 120 does not generate a TKC equal to a redeem and/or previously-generated TKC. Further, in some arrangements, the TKC circuit 120 searches the generated TKC database 121 to determine the validity of a TKC entered by a funds designee. For example, upon entering a TKC via an ATM (e.g., ATM 104), the TKC circuit 120 searches for a generated TKC in the generated TKC database 121 to determine whether the entered TKC exists (e.g., is valid) and has not been previously redeemed. In some such arrangements, if the entered TKC matches a generated TKC stored in the generated TKC database 121, then the TKC circuit 120 indicates the entered TKC as a valid TKC (e.g., the entered TKC is eligible for cash redemption). On the contrary, if the entered TKC does not match a generated TKC stored in the generated TKC database 121, the TKC circuit 120 indicates that the entered TKC is an invalid TKC (e.g., the TKC for redemption cannot be redeemed for cash, the TKC does not exist). Further, in some embodiments in which the entered TKC matches a redeem TKC stored in the generated TKC database 121, then the TKC circuit 120 indicates that the entered TKC has been previously redeem for the associated amount of cash (e.g., the TKC is now invalid).

The system 100 is also shown to include an ATM 104. In general, the ATM 104 is a computing system structured to provide an interface between a user and the provider computing system 102, allowing the user to access information and perform transactions with the corresponding provider. For example, in various arrangements, the ATM 104 is configured to allow a customer to view account balances, deposit checks, transfer funds, or withdraw funds from a given account in the form of cash. In some embodiments, the ATM 104 is configured to provide an interface between a user and the provider computing system 102 to conduct transactions associated with TKCs. More specifically, the ATM 104 is structured to provide the capabilities for a user to redeem a TKC for an associated amount of cash or transfer the associated amount of cash into an account the user holds with the provider. In some embodiments, the ATM 104 is structured to provide the capabilities for a user to conduct a transaction in which a TKC is generated and transmitted to a funds designee.

As shown, and for the purpose of clarity, the disclosure contained herein is in reference to a single ATM 104. This depiction is for illustrative purposes only to show an implementation environment of the systems and methods described herein. It should be understood that the provider computing system 102 may be communicably and operatively coupled with multiple ATMs that may have the same or similar characteristics as illustrated with the example embodiment of ATM 104. The ATM 104 is shown to include a network interface circuit 122 that facilitates connection of the ATM 104 to the network 110. The network interface circuit 122 of the ATM 104 is adapted for and configured to establish a communication session via the network 110 between the ATM 104 and other systems, such as the provider computing system 102, user device 106, and the POS computing system 108. Accordingly, the network interface circuit 122 includes any of a cellular transceiver (Code Division Multiple Access (CDMA), Global System for Mobile Communications (GSM), Long-Term Evolution (LTE)), a wireless network transceiver (e.g., 802.11X, ZigBee, Bluetooth), or a combination thereof (e.g., both a cellular transceiver and a Bluetooth transceiver). In some embodiments, the network interface circuit 122 communicates via a secured wired connection within a branch of the provider associated with the provider computing system 102. The network interface circuit 122 may be the same or similar as the network interface circuit 112 previously described with reference to the provider computing system 102.

The ATM 104 is shown include a processing circuit 124 including a processor 126 and memory 128. The processing circuit 124, processor 126, and memory 128 may be the same or similar as the processing circuit 114, processor 116, and memory 118 described respectively with reference to the provider computing system 102. The ATM 104 is shown to include an input/output (IO) circuit 130 structured to receive and provide communications to a user (e.g., a bank teller) of the ATM 104 (or, to another entity such as the provider computing system 102). In this regard, the IO circuit 130 is structured to exchange data, communications, instructions, etc. with the user device 106 and/or a user associated with the user device 106. Accordingly, in one embodiment, the IO circuit 130 includes an input/output device such as a display device, a touchscreen, a keyboard, a microphone, a barcode scanner, and/or a QR scanner. In various arrangements, the IO circuit 130 includes communication circuitry for facilitating the exchange of data, values, messages, and the like between an input/out device and the components of the ATM 104. In some embodiments, the IO circuit 130 includes machine-readable media for facilitating the exchange of information between the input/out device and the components of the ATM 104. In still another embodiment, the IO circuit 130 includes any combination of hardware components (e.g., a touchscreen), communication circuitry, and machine-readable media.

The IO circuit 130 includes hardware structured to facilitate input of a TKC by scanning a TKC on a display by user device 106 and/or by manual input by a funds designee. In some embodiments, the IO circuit 130 includes a keypad structured to facilitate manual input of a TKC by the funds designee. For example, a funds designee inputs a TKC structured in an alphanumeric code using a keypad provided by the IO circuit 130. In other embodiments, the IO circuit 130 includes a scanner structured to read a code (e.g., a one-time passcode, a QR code, a barcode)) associated with a TKC which can be presented to the scanner via a screen of the user device 106, a printed receipt, etc. For example, a funds designee presents a barcode that is generated on an interface of user device 106 to a scanner provided by the IO circuit 130 for reading of the barcode by the scanner. In some embodiments, the hardware provided by the IO circuit with which a funds designee can input a TKC depends on the type (e.g., a one-time passcode, a QR code, barcode, alphanumeric) of TKC received by the funds designee.

In various arrangements, the IO circuit 130 provides components, devices, and/or hardware to facilitate authorization of credentials of a funds designee redeeming a TKC. As previously described with reference to the TKC circuit 120 of the provider computing system 102, a generated TKC requires a funds designee authentication (e.g., biometric scan, facial recognition, PIN input) to confirm the credentials of the funds designee associated with the generated TKC. As such, the IO circuit 130 includes one or more components, devices, and corresponding hardware to verify such credentials of the funds designee. The types of components, devices, and hardware provided by the IO circuit 130 are configurable based on the structure of ATM 104, provider preference, and/or retailer preference. For example, a retailer prefers to require facial recognition of a funds designee for redemption of a TKC, and based on the facial recognition preference, the IO circuit 130 includes a camera and the corresponding hardware to facilitate a facial recognition process.

The ATM 104 is also shown to include a TKC interpreter circuit 132 structured to receive a TKC and interpret the TKC to determine a cash amount associated with the TKC. In some embodiments, the TKC interpreter circuit 132 communicates with IO circuit 130 to receive the TKC entered by the funds designee. Accordingly, the TKC interpreter circuit 132 is communicably and operatively coupled to the IO circuit 130. In some such embodiments, the TKC interpreter circuit 132 is configured to decipher data (e.g., cash amount associated with TKC, funds designee authorization requirements) from an entered TKC. In various arrangements, the TKC interpreter circuit 132 is configured to receive and decipher various types of codes (e.g., a one-time passcode, a barcode, QR code, alphanumeric). In some arrangements, the TKC interpreter circuit 132 communicates with the TKC circuit 120 to determine the validity of the TKC and/or funds designee authorization requirements. In this regard, the TKC interpreter circuit 132 is communicably coupled to the TKC circuit 120. For example, TKC interpreter circuit 132 transmits a TKC to the TKC circuit 120 to determine, by the TKC circuit 120, if the particular TKC exists in the generated TKC database 121. Further, the TKC interpreter circuit 132 communicates with the TKC circuit 120 to confirm, approve, and/or otherwise verify credentials of the funds designee. For example, as a requirement of redeeming a TKC, the funds designee enters a PIN. Accordingly, the TKC interpreter circuit 132 receives the PIN and communicates with the provider computing system 102 to confirm the credentials (e.g., the PIN) of the funds designee.

The ATM 104 includes a display 134 used to present account information, transaction information, and the like to users on the ATM 104. In this regard, the display 134 is communicably and operatively coupled to the IO circuit 130 to provide a user interface for receiving and displaying information on the ATM 104. Examples of user interfaces include digital screens, lights, voice instructions, etc. In various arrangements, the display 134 provides instructions (e.g., determined by the IO circuit 130, determined by the TKC interpreter circuit 132) to the user for facilitating an ATM transaction. For example, the display 134 presents an instruction to a user requesting that the user inputs a TKC or scan (via a scanner provided by the IO circuit 130) a barcode TKC. In this regard the display 134 is configured to display information (e.g., cash amount associated with the TKC) correlating to a TKC entered by a user.

As shown, the ATM 104 includes a cash dispenser 136 structured to dispense a predetermined amount of cash to a user of the ATM 104. In this regard, the cash dispenser 136 is communicatively and operatively coupled to the IO circuit 130 and/or the TKC interpreter circuit 132 to dispense an amount of cash associated with a TKC. In various arrangements, the cash dispenser 136 is communicatively and operatively coupled to the provider computing system 102 allowing a user to perform generic ATM transaction techniques that do not necessarily required a TKC (e.g., deposit a cash/check into an account, withdraw funds from an account).

The system is also shown to include a user device 106 which is a computing device associated with a user (e.g., a funds transferor, a funds designee). In some arrangements, the user is an account holder of at least one account managed by the provider (associated with provider computing system 102). An example account includes a checking account, a savings account, a credit account, an investment account, a retirement account, a brokerage account, a mortgage account, a rewards account, and the like. Such accounts include information indicating account balances, account activities, profile information (e.g., contact information of user), ATM transaction history, etc. However, as will be described in greater detail below, a funds designee does not need to hold at least one account managed by the provider (e.g., a funds designee may hold one or more other accounts at one or more different providers relative to the provider associated with provider computing system 102).

The user device 106 includes any type of computing device that is used to conduct financial transactions and/or receive information from the provider computing system 102, the ATM 104, and/or the POS computing system 108. In some arrangements, the user uses the user device 106 to both communicate information to the provider computing system 102 over the network 110 as well as communicate information with the ATM 104 and POS computing system 108. In this regard, the user device 106 may include any wearable or non-wearable device. Wearable devices refer to any type of device that an individual wears including, but not limited to, a watch (e.g., a smart watch), glasses (e.g., eye glasses, sunglasses, smart glasses), bracelet (e.g., a smart bracelet), etc. In such embodiments, a TKC is valid for redemption at times when the user is wearing the wearable device. The user device may also include any type of mobile device including, but not limited to, a phone (e.g., smart phone), tablet, personal digital assistant, key fob, card/badge, and/or computing devices (e.g., desktop computer, laptop computer, personal digital assistant).

In the example embodiment of FIG. 1, the user device 106 includes a network interface circuit 138 enabling the user device 106 to exchange information over the network 110, a processing circuit 140, and a location position sensor 150. The processing circuit 140 is shown to include a processor 142 and memory 144 including a client application circuit 146 and a merchant application circuit 148. The processing circuit 140, processor 142, and memory 144 may be the same or similar as the processing circuit 114, processor 116, and memory 118 respectively described with reference to the provider computing system 102.

The network interface circuit 138 of the user device 106 is adapted for and configured to establish a communication session via the network 110 between the user device 106 and other systems, such as the provider computing system 102, ATM 104, and the POS computing system 108. Accordingly, the network interface circuit 138 includes any of a cellular transceiver (Code Division Multiple Access (CDMA), Global System for Mobile Communications (GSM), Long-Term Evolution (LTE)), a wireless network transceiver (e.g., 802.11X, ZigBee, Bluetooth), or a combination thereof (e.g., both a cellular transceiver and a Bluetooth transceiver). In some embodiments, the network interface circuit 138 communicates via a secured wired connection within a branch of the provider associated with the provider computing system 102. The network interface circuit 138 may be the same or similar as the network interface circuit 112 previously described with reference to the provider computing system 102.

The client application circuit 146 is structured to provide displays to the user device 106 that enable the user to manage provider accounts. Accordingly, the client application circuit 146 is communicably and operatively coupled to the provider computing system 102. In some embodiments, the client application circuit 146 may be incorporated with an existing application in use by the provider (e.g., a mobile banking application or a mobile wallet application). In other embodiments, the client application circuit 146 may be downloaded by the user device 106 prior to its usage, hard-coded into the memory 144 of the user device 106, or be a web-based interface application, which may be executed remotely from the user device 106. In the latter instance, the user may have to log onto or access the web-based interface before usage of the application. Further, and in this regard, the client application circuit 146 may be supported by a separate computing system including one or more servers, processors, network interface circuits, etc. that transmit applications for use to the user device 106. In certain embodiments, the client application circuit 146 includes an API and/or a software development kit (SDK) that facilitate the integration of other applications with the client application circuit 146.

In various arrangements, and as will be described in greater detail with the various use-case scenarios below, the client application circuit 146 is structured to present a TKC to a funds designee via a user interface generated by the user device 106. In such arrangements, the client application circuit 146 presents a funds designee with a TKC generated by the TKC circuit 120. For example, upon completing a cash transaction at a retailer, a funds designee receives the generated TKC associated with the change due from the cash transaction via the client application circuit 146. In some arrangements, the client application circuit 146 presents the funds designee with various options to redeem a received TKC based on the credentials of the funds designee with the provider. For example, a particular funds designee who holds an account (e.g., a checking account, a savings account, a credit account) with the provider (associated with provider computing system 102) is presented with one or more options including, but not limited to, depositing the funds associated with the TKC into the account with the provider, redeeming the TKC for an online purchase, and/or locating a nearest ATM. In another example, a funds designee who does not hold an account with the provider is presented with the option to deposit the funds associated with the TKC into an account.

The user device 106 is shown to further include a merchant application circuit 148. The merchant application circuit 148 is configured to receive transaction information of one or more completed transactions, receive one or more TKCs associated with the one or more completed transactions, and manage an account a customer associated with the user device 106 holds with the retailer associated with the POS computing system 108. As such, the merchant application circuit 148 is communicably and operatively coupled to the POS computing system 108 to receive TKCs, transaction information, and account information. In various arrangements, the merchant application circuit 148 receives one or more TKCs and the transaction information (e.g., items bought, total purchase cost, change associated with a particular TKC) associated with the one or more TKCs and stores the TKCs and transaction information with an account a customer holds with the retailer. In such arrangements, a customer can redeem the one or more TKCs for online purchases from the retailer via the merchant application circuit 148.

The location position sensor 150 is structured to receive location data and determine a location or receive information indicative of a location of the user device 106. In one embodiment, the location position sensor 150 includes a global position system (GPS) or any other type of location position system. As such, the location position sensor 150 receives latitude data, longitude data, and other types of location or position data to determine the location of the user device 106. In other embodiments, the location position sensor 150 receives and explicit location identification from a user of the user device 106. All such variations are intended to fall with the spirit and scope of the present disclosure.

In various arrangements, the location data received by the location position sensor 150 is used (e.g., by the client application circuit 146, by the provider computing system 102) to determine one or more ATMs (e.g., ATM 104) associated with the provider of provider computing system 102 that are nearest the user. In such arrangements, the client application circuit 146 presents the one or more ATMs nearest the user as potential TKC redemption locations to the user.

Still referring to FIG. 1, the POS computing system 108 is shown to include a network interface circuit 152 enabling the POS computing system 108 to exchange information over the network 110 and a processing circuit 154. The processing circuit 154 is shown to include a processor 156 and memory 158 including a client application circuit 160 and a TKC interpreter circuit 162. The processing circuit 154, processor 156, and memory 158 may be the same or similar as the processing circuit 114, processor 116, and memory 118 described respectively with reference to the provider computing system 102.

The POS computing system 108 is operated by a retailer, which is an entity that facilitates various types of transactions for goods and/or services provided by the retailer between a customer and the retailer. In various arrangements, the retailer is a store, grocery store, market, hardware store, clothing store, electronics store, book store, a pharmacy, a convenience store, a gas station, or other similar entities. In some embodiments, the retailer is a restaurant, a café, a bar, food truck, bistro, diner, cafeteria, or other similar entities.

The POS computing system 108 includes any type of computing device that may be used to conduct financial transactions and/or receive information from the provider computing system 102, the ATM 104, and/or the user device 106. In some arrangements, the POS computing system 108 may be a point-of-sale (POS) terminal (e.g., a checkout computing system, a self-service checking computing system, a drive-through terminal) structured to facilitate a transaction for goods sold by the retailer associated with the POS computing system 108.

The POS computing system 108 is shown to include a client application circuit 160 communicably coupled to the provider computing system 102 and/or the user device 106. In certain embodiments, the client application circuit 160 includes an API and/or a software development kit (SDK) that facilitate the integration of other applications with the client application circuit 160. In various arrangements, the client application circuit 160 transmits transaction signals and requests to generate a TKC to the provider computing system 102. In various arrangements, the client application circuit 160 receives a generated TKC from the provider computing system 102.

The POS computing system 108 is also shown to include a TKC interpreter circuit 162 communicably coupled to the provider computing system 102 and/or user device 106. In various arrangements, the TKC interpreter circuit 162 is the same or similar to the TKC interpreter circuit 132 of the ATM 104 such that the TKC interpreter circuit 162 is structured to receive a TKC and interpret the TKC to determine a cash amount associated with the TKC. In some embodiments, the TKC interpreter circuit 162 is configured to decipher data (e.g., cash amount associated with TKC, user authorization requirements) from an entered TKC. In various arrangements, the TKC interpreter circuit 162 is configured to receive and decipher various types of codes (e.g., a one-time passcode, a barcode, QR code, alphanumeric). In some arrangements, the TKC interpreter circuit 162 communicates with the TKC circuit 120 (provided by the retailer computing system 102) to determine the validity of the TKC and/or user authorization requirements. For example, TKC interpreter circuit 162 transmits a TKC to the TKC circuit 120 to determine, by the TKC circuit 120, if the particular TKC exists in the generated TKC database 121 and user authentication information.

In various arrangements, system 100 includes a blockchain-based system (not shown) structured to monitor TKC generation, store information associated with each generated TKC, and allow for real-time updates of the information based on changes associated with the TKC. As such, the blockchain-based system may be communicably and operatively coupled to one or more of the provider computing system 102, ATM 104, user device 106, and POS computing system 108 such that access to the blockchain-based system is available to the provider computing system 102, ATM 104, user device 106, and POS computing system 108. Such information that can be stored in the information blocks of the blockchain-based system include generation of a TKC, time of generation of the TKC, identification (e.g., identification number, identification characters) of the TKC, monetary value associated therewith, type of TKC, identification of a user to which the TKC is granted, etc.

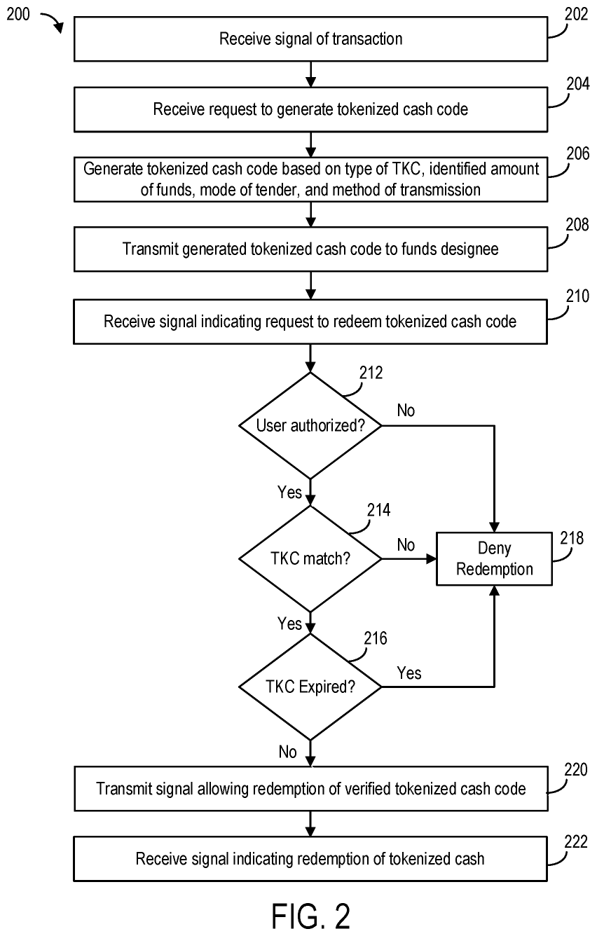

Referring now to FIG. 2, a flowchart of a method 200 of generating a TKC and verifying the TKC for redemption is shown, according to an example embodiment. In various embodiments, the method 200 is performed by the components of system 100 shown in FIG. 1 such that reference may be made to components of FIG. 1 to aid the description of method 200. Through the method 200, the provider computing system 102 provides a TKC to a funds designee, verifies the credentials and validity of the TKC for redemption of the TKC by the funds designee, and stores the generated TKC in generated TKC database 121.

The method 200 can be implemented in a variety of exemplary situations. A first exemplary situation includes performing method 200 in a retail setting including a retailer that provides goods to customers and issues change from cash transactions in the form of a change TKC. A customer interacts with a retailer POS terminal (e.g., POS computing system 108) to purchase goods provided by the retailer. In lieu of providing cash change to the customer, a change TKC (as can be generated by performing method 200) is provided to the customer for redemption of the amount of funds defined by change based on the completed transaction.

Another exemplary implementation of the method 200 is a retail setting including a retailer that provides services to customers (e.g., a restaurant, a café, a valet). The method 200 provides a desirable option for such retailers to offer payment of tips from patrons of the retailers to employees of the retailer based on patrons completing a transaction including a tip allocated to the employee by means of a credit card, debit card, and the like (herein referred to as “card”). The term “tip” as used herein is defined as a sum of money given as a bonus for one's service. By performing the method 200, the tips allocated to an employee from a retailer patron by a card transaction are redeemable for cash via a generated tip TKC associated with the allocated tip amount. In various arrangements, the tip TKC generated by performing method 200 is generated at the end of a pay period (e.g., every 2 weeks). For example, in the case in which the tip TKC is generated at the end of a pay period, the tip TKC generated is redeemed by the employee for the total amount of allocated tips of card transactions completed over the pay period. In some embodiments, the tip TKC generated by performing method 200 is generated based on each card transaction completed by a retailer patron.

A third exemplary implementation of the method 200 is a cash transfer scenario. The method 200 provides an option for generating a funds transfer TKC representing an amount of funds desired to be transferred from a funds transferor to a funds designee. For example, a funds transferor user desires to transfer an amount of funds to a funds designee but does not desire to withdraw the amount of funds in the form of cash or compose a check for the amount of funds. By performing method 200, a funds transfer TKC can be generated representing the amount of funds for transfer from the funds transferor to the funds designee with which the funds designee redeems for the amount of funds.

A signal of a transaction is received at step 202. In some arrangements, the transaction signals are received at the provider computing system 102 from the POS computing system 108. In various embodiments, the transaction signal includes information such as retailer name/identification, items bought, total cost of transaction, and patron identification. In some embodiments, upon receipt of the transaction signal, the transaction information is associated and/or stored with a provider account of the user who conducted the transaction. In some arrangements, the transaction signal and transaction information included therein is received by merchant application circuit 148 for access of the transaction information by the user of the user device 102.

In various arrangements, the transaction signal received at step 202 indicates a card transaction in which a patron of a retailer allocated tips to an employee of the retailer by payment via a card (e.g., accredit card, debit card, gift card). In such arrangements, the transaction signal includes data such as identification of the retailer, tip allocation amount, card account holder (e.g., retailer patron) identification, and/or identification of the employee to whom the tip was allocated. In various embodiments, step 202 is performed multiple times during the duration of a pay period. For example, each card transaction completed over a two-week pay period is received by the provider computing system 102 such that the tip allocation amount associated with each card transaction received during the two-week pay period is summed.

In some embodiments, a transaction signal indicating a funds transfer transaction is received at step 202. In such embodiments, the signal received at step 202 is indicative of a transaction in which a funds transferor wishes to transfer funds from an account associated with the funds transferor to a funds designee. In various arrangements, the funds transfer transaction signal is transmitted from the user device 106 and/or ATM 104 to the provider computing system 102. The funds transfer transaction signal includes data such as identification of the funds transferor transferring funds, account information from which funds will be transferred, amount of funds desired for transfer, and/or cash transfer designee (e.g., identification of the individual designated to receive the funds).

A request to generate a TKC is received at step 204. In some arrangements, the request is received by the provider computing system 102 from the POS computing system 108. More specifically, the request is received by the TKC circuit 120. The request includes an indication of a type of TKC (e.g., a one-time passcode, an alphanumeric code, QR code, barcode), and the type of TKC is configurable and/or selectable by the retailer associated with the POS computing system 108 or the user conducting a transaction with the retailer. For example, a funds designee indicates that he/she wishes to receive a TKC in the form of a QR code. In another example, the retailer associated with the POS computing system 108 offers, on behalf of the provider computing system 102, one or more TKC types (e.g., a barcode, an alphanumeric code) that are preferred by the retailer such that the retailer offers only the one or more preferred TKC types to customers. In some arrangements, an identified amount of funds is received as part of the TKC request indicating to the provider computing system 102 the specific amount of funds to be tokenized with the TKC. In various arrangements, the request to generate a TKC includes funds designee authorization information (e.g., preferred method of funds designee authorization technique, funds designee authorization information). Further, in various arrangements, the level, or otherwise complexity, of the funds designee authorization associated a TKC depends on the amount of funds tokenized by the TKC. As such, the greater the amount of funds tokenized by the TKC, the greater the complexity of funds designee authorization applied to the TKC.

In various arrangements, as part of the request to generate a TKC, a desired method of transmission is received. For example, the desired method of transmission includes receiving the TKC via a user device (e.g., user device 106), a printed receipt, a POS terminal, or some other device with which the funds designee observes and/or records the TKC. In some arrangements, the request to generate a TKC received at step 204 includes a time limit of the TKC. The time limit of the TKC is a predetermined amount of time (e.g., as determined by the retailer, the provider, the funds transferor, type of TKC, amount of cash for transferring via the TKC) for which the TKC is valid for redemption for the corresponding amount of cash. In some arrangements, the request to generate a TKC received at step 204 includes a request to generate a change TKC. The request can include information such as method of change TKC distribution (e.g., printed receipt, transmission of change TKC to user device) and mode of tender (e.g., redemption of change TKC for cash, change TKC gift card).

In various arrangements, the request to generate a TKC received at step 204 includes a request to generate a tip TKC associated with one or more allocated tips. The request can include information such as desired method of tip TKC distribution (e.g., printed on employee paycheck, transmission of tip TKC to user device) and mode of tender (e.g., redemption of tip TKC for cash, tip TKC gift card). In various arrangements, the request to generate a tip TKC is received by the provider computing system 102 at the end of a pay period defined by the retailer. For example, the request to generate a tip TKC to tokenize all tips allocated to a particular employee by one or more card transactions over the duration of a two-week pay period is received at the end of the two-week pay period. Alternatively, the request is received after each card transaction signal is received.

In some embodiments, the request to generate a TKC received at step 204 includes a request to generate a funds transfer TKC associated with an amount of funds desired to be transferred. The request can include information such as method of funds transfer TKC distribution (e.g., printed receipt, transmission of funds transfer TKC to user device) and mode of tender (e.g., redemption of funds transfer TKC for cash, funds transfer TKC gift card). In various arrangements, the request to generate a funds transfer TKC indicates the particular funds designee of the generated funds transfer TKC.

The TKC is generated at step 206. In some arrangements, the TKC is generated by the TKC circuit 120 of the provider computing system 102. In various arrangements, generating the TKC involves generating a code that is substantially different than one or more previously-generated TKCs such that the generated TKC is unique relative to the one or more previously-generated TKCs and/or redeemed TKCs stored in the generated TKC database 121. For example, the TKC circuit 120 generates a code that is substantially different than any generated code that is stored in the generated TKC database 121. In various arrangements, generating a TKC involves generating a one-time passcode, a QR code, a barcode, or an alphanumeric code to tokenize the cash amount received in step 204. Further, generating the specific type of TKC depends on funds transferor, funds designee, and/or retailer selection (as described with reference to step 204). It should be understood that the previously described types of codes are not intended to limiting. Any additional type of code may be included to facilitate the generation and use of tokenized cash.

Step 206 involves generating a TKC based on the information received at step 204 such as the identified amount of funds (e.g., indicated by the funds transferor, indicated by the POS computing system), the mode of tender (e.g., redemption for cash, a gift card), and the method of transmission (e.g., a printed receipt, sent to user device 106). In various embodiments, generating the TKC involves generating a time limit corresponding with the TKC as can be indicated by the retailer, funds transferor, or provider. Further, in some embodiments, generating the TKC involves generating a user authorization technique associated with the TKC. For example, as part of generating a TKC, the TKC circuit 120 applies a requirement to authorize the funds designee (e.g., by entering a pin, by facial recognition) with the generated TKC.

In such embodiments, generating a change TKC further involves applying customer authorization techniques to generate the change TKC. For example, a PIN selectable by the customer is applied to the change TKC. In some embodiments, step 206 involves generating a tip TKC to represent an amount of tips allocated to an employee and applying employee authorization techniques to the tip TKC. For example, an employee identification number of the employee is applied to the tip TKC such that the employee identification number must be entered for the tip the tip TKC to be redeemed. In various arrangements, step 206 involves generating a funds transfer TKC and involves applying funds designee authentication information to the funds transfer TKC generated. For example, a pin selectable by the funds transferor and/or the funds designee is applied to the funds transfer TKC.

The generated TKC is transmitted in step 208. In some arrangements, the generated TKC is transmitted from provider computing system 102 to user device 106. For example, a funds designee selects to receive a TKC on the user device 106. As such, the provider computing system 102 transmits the TKC to the client application circuit 146 and/or the merchant application circuit 148 provided by the user device 106 associated with the funds designee. In some arrangements, the generated TKC is transmitted to the POS computing system 108. More specifically, the generated TKC is transmitted to the POS computing system 108 for printing of the TKC (e.g., on a receipt, on a paycheck) for the funds designee (e.g., customer of the retailer, an employee of the retailer) involved in the transaction. In some arrangements, the generated TKC is transmitted to the POS computing system 108 for presenting, to the funds designee involved in a transaction, the TKC via a user interface generated by the POS computing system 108.

A signal indicating a request to redeem a TKC is received at step 210. In some arrangements, the signal is transmitted from the ATM 104 to the provider computing system 102. For example, a funds designee who has received a TKC is redeeming, at an ATM, the TKC for the cash amount associated with the TKC such that a redemption request signal is transmitted form the ATM (e.g., ATM 104) to the provider computing system. In various arrangements, the signal is transmitted from the POS computing system 108 to the provider computing system 102. For example, a funds designee who has received a TKC is redeeming, at a retailer associated with the POS computing system 108, the TKC in exchange for goods provided by the retailer.

The user (e.g., the funds designee) who transmitted the request to redeem the TKC is authorized using the authorization information at step 212. Verifying the user may involve any means of security authenticity (e.g., a PIN, an account number, a driver's license number, date of birth, address confirmation, cash amount associated with the TKC). For example, the user may is prompted to input his/her driver's license number at the ATM 104 in order for the provider computing system 102 to confirm that the user who is attempting to redeem the TKC is the intended funds designee. In some embodiments, the TKC redemption is denied at step 218 if the user is not determined to be authorized to redeem a particular TKC. In such embodiments, the user is prompted to try inputting the means of user authorization and/or select another user authorization technique that is different than the first attempt. In some embodiments, the inputted TKC is analyzed if it has been determined that the user is authorized to redeem the TKC.

The inputted TKC is analyzed to determine if the inputted TKC matches a generated TKC code at step 214. In various arrangements, verifying the TKC involves the TKC circuit 120 comparing the TKC for verification against the generated TKCs and/or redeemed TKCs stored in the generated TKC database 121. If the TKC for verification matches a generated TKC stored in the generated TKC database 121, then the TKC for verification is considered verified (e.g., the TKC is valid). Further, if the TKC for verification does not match a generated TKC stored in the generated TKC database 121, then the TKC for verification is considered invalid (e.g., the TKC does not exist). Additionally, if the TKC for verification matches a redeemed TKC stored in the generated TKC database, then the TKC for verification is considered invalid (e.g., the TKC has already been redeemed). Accordingly, the TKC redemption is denied at step 218. In some embodiments, the inputted TKC is further analyzed to determine if the TKC has expired based on the time to live associated with the inputted TKC at step 216. In various arrangements, determining if the TKC has expired involves the TKC circuit 120 comparing the time to live for the inputted TKC against the time at which the inputted TKC was generated to determine a lifetime of the inputted TKC. As such, a lifetime of a TKC is defined as the length of time from generation of a TKC to the time of input of the TKC. If it is determined that the lifetime of the TKC is greater than the time to live of the TKC, then the redemption of the TKC is denied (step 218). Alternatively, if it is determined that the lifetime of the TKC is less than the time to live of the TKC, then the TKC is not considered expired and may be eligible for redemption.

A signal allowing for the TKC to be redeemed for the cash amount associated with the TKC is transmitted at step 220. Such a signal may be defined as an approval signal indicating that the TKC is approved for redemption of the cash amount. In various arrangements, the signal is transmitted from the provider computing system 102 to the ATM 104. In such arrangements, the signal transmitted to the ATM 104 permits dispensing (e.g., via cash dispenser 136) of the amount of cash associated with the TKC for redemption. In some arrangements, the signal is transmitted from the provider computing system 102 to the POS computing system 108. In such arrangements, the signal transmitted to the POS computing system 108 permits redemption of the funds associated with the TKC in a transaction with the retailer. Further, in some embodiments, the signal is transmitted from the provider computing system 102 to the user device 106. In such embodiments, the signal transmitted to the user device 106 permits redemption of the funds associated with the TKC for an online transaction with the retailer or transferring of funds to an account held by the funds designee with the provider.

A signal indicating that the TKC has been redeemed is received at step 222. In various arrangements, the signal is received by the provider computing system 102. In some arrangements, the provider computing system 102 removes the redeemed TKC from future generation such that the redeemed TKC will not be generated in the future. In such arrangements, the redeemed TKC is flagged in the generated TKC database 121 as a “redeemed TKC” such that any future redemption attempt of the redeemed TKC will deny the redemption of funds associated with the redeemed TKC.

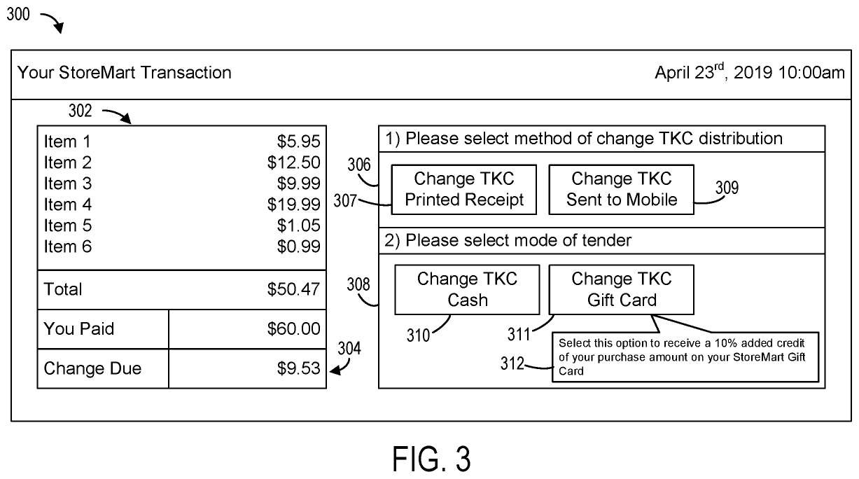

Referring now to FIG. 3, an example user interface 300 as generated by the POS computing system 108 and presented to a customer is shown, according to an example embodiment. The example user interface 300 provides an example interface of information displayed to a customer while completing a transaction. The user interface 300 includes a transaction area 302 where the customer can view the items for purchase, the total cost of all items selected by the customer, the amount of money paid by the customer, and/or the change 304 due in exchange for the amount of money paid by the customer.

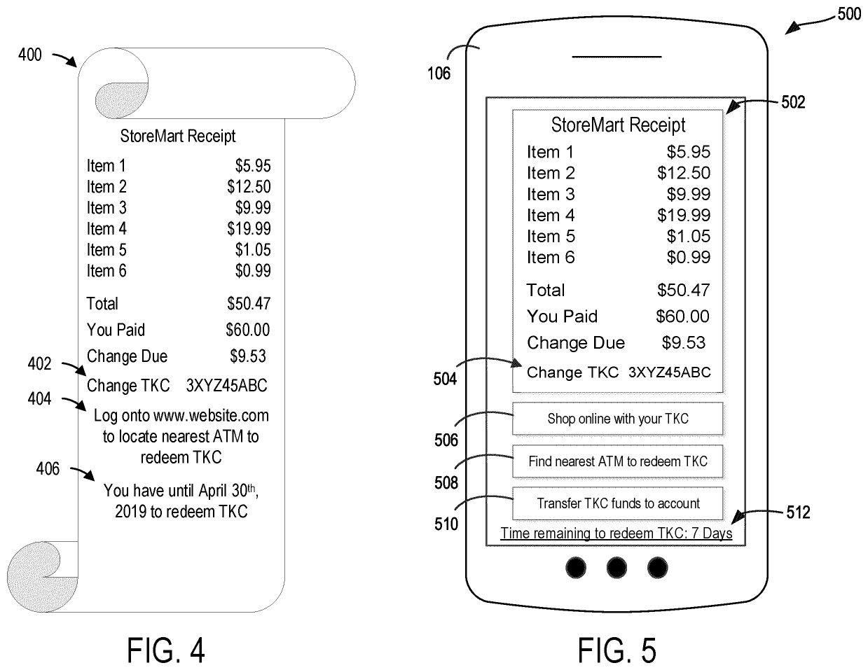

The user interface 300 also includes a change selection box 306 where the user can select the method of change TKC distribution. In some arrangements, the selection of the “change TKC printed receipt” selection option 307 prints a printed receipt including a generated change TKC as will be described with reference to the example receipt 400 of FIG. 4. In some embodiments, the selection of the “change TKC sent to mobile” selection option 309 transmits transaction information, a generated change TKC, and/or information for redemption of the change TKC as will be described with reference to the example user interface 500 of FIG. 5. In such embodiments, the user is prompted to enter further information (e.g., a phone number, an email address, account information, agreement to receive texts) upon selection of the “change TKC sent to mobile” selection option 309.

The user interface 300 also includes a tender selection box 308 where the user can select the mode of tender (e.g., cash redemption for the change TKC, change TKC gift card for use at the retailer). In some arrangements, the selection of the “change TKC cash” selection option 310 generates a change TKC that is eligible for redemption of the change due (e.g., change 304). In some embodiments, selection of the “change TKC gift card” selection option 311 generates a change TKC that eligible for redemption at the retailer associated with the particular transaction. Further, in some such embodiments, for selection of the “change TKC gift card” selection option 311, a reward bonus 312, is applied to the change TKC. As shown in FIG. 3, the reward bonus 312 includes 10% credit of the purchase amount added to the amount of change tokenized by the change TKC. As should be understood, the amount and/or type of reward associated with the reward bonus 312 is configurable based on the retailer and/or provider preference.

Referring now to FIG. 4, an example receipt 400 with a printed change TKC 402 is shown, according to an example embodiment. In various arrangements, the example receipt 400 is provided to the customer as a printed document upon selection of receiving the change TKC 402 via the receipt 400. For example with reference to FIG. 3, a customer selects the “change TKC printed receipt” selection option 307 when presented with the change selection box 306, and based on selection of the “change TKC printed receipt” selection option 307, receipt 400 is printed for the customer.

The change TKC 402 is shown as an alphanumeric code for redemption by the customer associated with the particular transaction indicated on the receipt 400. In various arrangements, the change TKC 402 printed on the receipt 400 is a one-time passcode, a barcode, a QR code, or any other symbol and/or combination of characters to tokenize a cash amount. The receipt 400 indicates that the change TKC 402 is eligible for redemption at an ATM (e.g., ATM 104) which the customer can locate via accessing the website 404. The customer who receives the receipt 400 may log onto the website 404 to determine one or more ATMs nearest the customer at which the customer may redeem the change TKC 402 for the change due. In some embodiments, the receipt 400 indicates that the change TKC 402 has a time limit 406 until Apr. 30, 2019. As previously described, the time limit 406 is configurable and/or selectable by the customer associated with the transaction, the provider associated with the generation of change TKC 402, and/or the retailer associated with the transaction. In various arrangements, the generation of change TKC 402 and transmission of the change TKC 402 to a customer (e.g., via printing of the receipt 400 via the POS computing system 108) can be facilitated by the various components of system 100 performing method 200.

Referring now to FIG. 5, an example user interface 500 of the user device (e.g., user device 106) presenting a change TKC 504 is shown, according to an example embodiment. The example user interface 500 is an example of an interface generated when a customer completes a transaction at a retailer and selects a change TKC to be transmitted to the user device 106, such as selecting the “change TKC sent to mobile” selection option 309 of FIG. 3. For example with reference to FIG. 3, a customer selects the “change TKC sent to mobile” selection option 309 when presented with the change selection box 306, and based on selection of the “change TKC sent to mobile” selection option 309, the change TKC 504 is transmitted to the user device 106 and presented to the customer on the user interface 500. In various arrangements, the example user interface 500 is generated via the client application circuit 146 and/or the merchant application circuit 148. The user device 106 includes a viewing area 502, where the customer can view the transaction information, the change TKC 504 and correlated information, and change TKC redemption selection options 506-510.

The change TKC 504 is presented to the customer in viewing area 502 and is shown as an alphanumeric code for redemption by the customer associated with the particular transaction. In various arrangements, the change TKC 504 is a one-time passcode, a barcode, a QR code, or any other symbol and/or combination of characters to tokenize a cash amount. The user interface 500 shows a “shop online with your TKC” selection option 506, a “find nearest ATM to redeem TKC” selection option 508, and a “transfer TKC funds to account” selection option 510. In various arrangements, the change TKC 504 is shown to have a time limit 512 defining an amount of time to redeem the change TKC 504 until the change TKC 504 is deemed invalid. As shown, the time limit 512 defines the amount of time as 7 days to redeem the change TKC 504. In various arrangements, the generation of change TKC 504 and transmission of the change TKC 504 to a customer (e.g., via user device 106) can be facilitated by the various components of system 100 performing method 200.

Upon selection of the “shop online with your TKC” selection option 506, the customer is directed to a website or a mobile application associated with the retailer (e.g., via the merchant application circuit 148 with reference to FIG. 1). The customer is eligible to redeem the change TKC 504 for purchase of goods via the merchant website or mobile application. Further, as previously described, the change TKC 504 includes a reward bonus (e.g., reward bonus 312 with reference to FIG. 3) for redemption of the change TKC 504 at a physical location merchant location, merchant website, or mobile application.

Upon selection of the “find nearest ATM to redeem TKC” selection option 508, the customer is directed to a website or mobile application associated with a provider (e.g., via the client application circuit 146 with reference to FIG. 1). Using location information received by the location position sensor 150, the client application circuit 146 and/or provider website locates one or more ATMs nearest the customer at which the customer can redeem the change TKC 504.

Further, upon selection of the “transfer TKC funds to account” selection option 510, the customer can transfer the funds associated with the change TKC 504 to an account held by the customer with the provider. In various arrangements, the customer can transfer the funds associated with the change TKC 504 to an account associated with the provider of provider computing system 102. For example, a customer who has received the change TKC 504 transfers the funds associated with the change TKC 504 to a checking account the customer holds with the provider of provider computing system 102. In other arrangements, the customer can transfer the funds associated with the change TKC 504 to an account associated with the retailer of POS computing system 108. For example, a customer who has received the change TKC 504 transfers funds associated with the change TKC 504 to an online account provided by the retailer. Further, in some such arrangements, the customer can store and compile funds associated with one or more change TKCs from previous and future transactions via the online account provided by the retailer and/or provider.

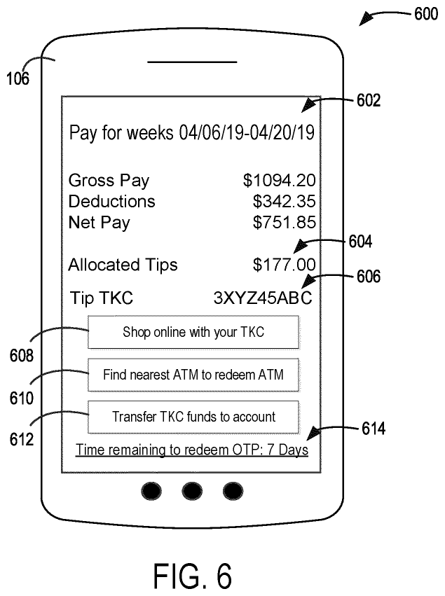

Referring now to FIG. 6, an example user interface 600 of the user device (e.g., user device 106) presenting a tip TKC 606 is shown, according to an example embodiment. The example user interface 600 is an example of an interface generated when a user is presented with the tip TKC 606 associated with the allocated tips 604. In various arrangements, the example user interface 600 is generated via the client application circuit 146. The user device 106 includes a viewing area 602, where the user can view the paycheck information including the amount of allocated tips 604, tip TKC 606 and correlated information, and TKC redemption selection options 608-612.

The viewing area 602 indicates that the payment information is for a two-week pay period. As such, the allocated tips 604 are a summation of all allocated tips received via a card transaction over the two-week pay period. The corresponding tip TKC 606 is shown as a single tip TKC tokenizing the allocated tips 604 received via a card transaction over the two-week pay period. Conversely, the viewing area 602 presents multiple instances of tip TKC 606, whereby each instance of tip TKC 606 represents an allocated tip from a single card transaction.

The user interface 600 shows a “shop online with your TKC” selection option 608, a “find nearest ATM to redeem TKC” selection option 610, and a “transfer TKC funds to account” selection option 612. In various arrangements, the tip TKC 606 is shown to have a time limit 614 defining an amount of time to redeem the tip TKC 606 until the tip TKC 606 is deemed invalid. As shown, the time limit 614 defines the amount of time as 7 days to redeem the tip TKC 606.

Upon selection of the “shop online with your TKC” selection option 608, the employee is be directed to a website or a mobile application associated with an external merchant. The employee is be eligible to redeem the tip TKC 606 for purchase of goods via the merchant website or mobile application. Upon selection of the “find nearest ATM to redeem TKC” selection option 610, the employee is directed to a website or mobile application associated with a provider (e.g., via the client application circuit 146 with reference to FIG. 1). Using location information received by the location position sensor 150, the client application circuit 146 and/or provider website locates one or more ATMs nearest the employee at which the employee can redeem the tip TKC 606.

Further, upon selection of the “transfer TKC funds to account” selection option 612, the employee can transfer the funds associated with the tip TKC 606 to an account held by the employee with the provider. In various arrangements, the employee can transfer the funds associated with the tip TKC 606 to an account associated with the provider of provider computing system 102. For example, an employee who has received the tip TKC 606 can transfer the funds associated with the tip TKC 606 to a checking account the employee holds with the provider of provider computing system 102.

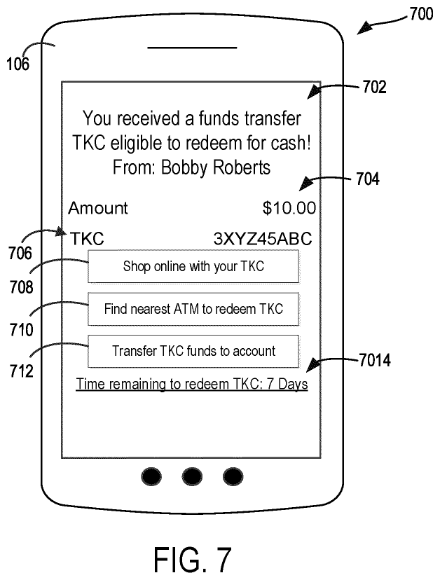

Referring now to FIG. 7, an example user interface 700 of the user device (e.g., user device 106) presenting a funds transfer TKC 706 is shown, according to an example embodiment. The example user interface 700 is an example of an interface generated when a funds designee is presented with the funds transfer TKC 706 associated with the amount 704. In various arrangements, the example user interface 700 is generated via the client application circuit 146. The user device 106 includes a viewing area 702, where the funds designee can view the funds transfer information including the funds transfer amount 704, funds transfer TKC 706 and correlated information, identification of the funds transferor, and TKC redemption selection options 708-712.

The user interface 700 shows a “shop online with your TKC” selection option 708, a “find nearest ATM to redeem TKC” selection option 710, and a “transfer TKC funds to account” selection option 712. In various arrangements, the funds transfer TKC 706 is shown to have a time limit 714 defining an amount of time to redeem the funds transfer TKC 706 until the funds transfer TKC 706 may be deemed invalid. As shown, the time limit 714 defines the amount of time as 7 days to redeem the funds transfer TKC 706. Upon expiration of the funds transfer TKC 706 past the amount of time defined by the time limit 714, the funds transfer amount 704 are returned to a financial account associated with the funds transferor.

Upon selection of the “shop online with your TKC” selection option 708, the funds designee is directed to a website or a mobile application associated with an external merchant. The funds designee is eligible to redeem the funds transfer TKC 706 for purchasing of goods via the merchant website or mobile application. Upon selection of the “find nearest ATM to redeem TKC” selection option 710, the funds designee is directed to a website or mobile application associated with a provider (e.g., via the client application circuit 146 with reference to FIG. 1). Using location information received by the location position sensor 150, the client application circuit 146 and/or provider website locates one or more ATMs nearest the funds designee at which the funds designee can redeem the funds transfer TKC 706.

Further, upon selection of the “transfer TKC funds to account” selection option 712, the funds designee can transfer the funds associated with the funds transfer TKC 706 to an account held by the funds designee with the provider. In various arrangements, the funds designee can transfer the funds associated with the funds transfer TKC 706 to an account associated with the provider of provider computing system 102. For example, a funds designee who has received the funds transfer TKC 706 can transfer the funds associated with the funds transfer TKC 706 to a checking account the funds designee holds with the provider of provider computing system 102.

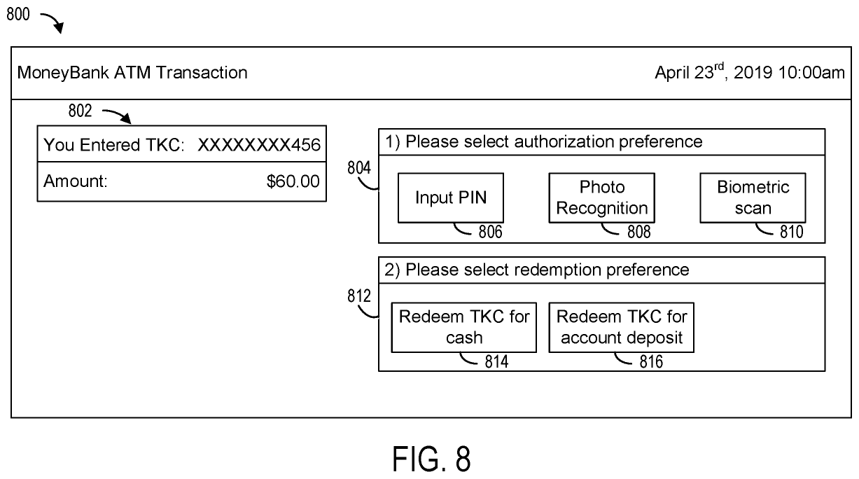

Referring now to FIG. 8, an example user interface 800 of an ATM is shown, according to an example embodiment. In various embodiments, the example user interface 800 is generated by display 134 provided by the ATM 104. The example user interface 800 is an example of an interface generated when a funds designee wishes to redeem a TKC. The user interface 800 includes a TKC input area 802, where a funds designee using the ATM can input a TKC. In various arrangements the funds designee inputs the TKC to the TKC input area 802 using a keyboard, scanner, touchscreen, or other hardware provided by the IO circuit 130 to facilitate the input of a TKC. As shown, the TKC input area 802 indicates the entered TKC and the cash amount associated with the particular TKC.

The user interface 800 is also shown to include an authorization selection area 804, where the funds designee can select a method of credential authorization to redeem the TKC entered in the TKC input area 802. The authorization selection area 804 is shown to include a PIN option 806, a photo recognition option 808, and a biometric scan option 810. Upon selection of the PIN option 806, the user interface 800 generates a keyboard with which a funds designee inputs a PIN associated with the TKC. In various arrangements, a designee inputs the PIN via a physical piece of input hardware (e.g., a keyboard, a keypad) provided by the IO circuit 130 or a touch screen keyboard (not shown) generated by the user interface 800. In some embodiments, the PIN is generated as part of the TKC generation process performed by the provider computing system 102. In other embodiments, the PIN is a PIN associated with an account that the funds designee holds with the provider.

Upon selection of the photo recognition option 808, a camera provided by the IO circuit 130 collects a photo of the funds designee and compare the photo to a photo stored by the provider associated with the provider computing system 102. By comparing the collected photo to the stored photo, the TKC circuit 120 can determine if the funds designee is authorized to redeem a particular TKC. Further, upon selection of the biometric scan option 810, a finger and/or palm scanner provided by the IO circuit 130 collects a biometric scan of the funds designee and compare the fingerprint/palm print to a fingerprint/palm print stored by the provider associated with the provider computing system 102. By comparing the collected fingerprint/palm print to the stored fingerprint/palm print, the TKC circuit 120 can determine if the funds designee is authorized to redeem a particular TKC. It should be understood that authorization options provided by the authorization selection area 1104 may be configurable based on retailer preference and/or provider preference. For example, in some arrangements, a user does have multiple authorization options to choose from. Rather, a predetermined authorization selected by the POS computing system 108 and/or the provider computing system 102 is presented to the user on the user interface 800.

The user interface 1100 is also shown to include a redemption selection area 812, where a user can select of method redemption of the cash associated with the TKC entered in TKC input area 802. The redemption selection area 812 is shown to include cash redemption option 814 and an account deposit option 816. Upon selection of either the cash redemption option 814 or the account deposit option 816, a TKC interpreter provided by IO circuit 130 is presented to the funds designee to read a TKC. For example, as previously described, a TKC interpreter provided by IO circuit 130 includes a keyboard, a scanner, and the like to facilitate to reading of a code. Upon selection of the cash redemption option 814 and following verification of the validity of an entered TKC by the TKC circuit 120, the ATM 104 dispenses the amount of cash associated with the entered TKC to the funds designee via cash dispenser 136. By selecting the account deposit option 816 and following verification of the validity of an entered TKC by the TKC circuit 120, the ATM 104 can transfer the amount of funds associated with the entered TKC to an account the funds designee holds with the provider associated with provider operating system 102.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on).

The “circuit” may also include one or more dedicated processors communicatively coupled to one or more dedicated memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, et.), microprocessor, etc.

An example system for implementing the overall system or portions of the embodiments might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A system, comprising:
a user device of a user; and
a provider computing system associated with a provider, the provider computing system comprising:
a network interface structured to facilitate data communication via a network;
a processing circuit comprising a processor and memory, the processing circuit structured to receive a request to generate a tokenized cash code (TKC) from a point of sale (POS) system, the request indicating a monetary amount and the user device of the user, and wherein the processing circuit determines an authentication method for the TKC based on the monetary amount and based on authorization preferences of the user;
wherein the memory comprises a TKC circuit structured to:
generate the TKC associated with the monetary amount, wherein the TKC associated with the monetary amount is structured for redemption of the monetary amount at a retailer POS system or an automated teller machine (ATM), the TKC associated with an expiration time; and
transmit the TKC to the user device of the user indicated in the request, wherein the TKC circuit receives a security authenticator from the user device to authenticate the TKC according to the determined authentication method; and
a generated TKC database storing the TKC and the security authenticator received from the user device, wherein the generated TKC database is communicably coupled to the TKC circuit to determine a generated TKC,
wherein the user device is structured to:
present a graphical user interface comprising a printable receipt generated by the POS system, the printable receipt indicating a corresponding transaction at the POS system, an identifier of the TKC, and the expiration time of the TKC, the graphical user interface further comprising a selectable option that, when selected, causes the user device to be directed to a provider website of the provider configured to identify, based on location information of the user device, one or more automated teller machines (ATMs) capable of redeeming the TKC;
wherein the provider computing system is structured to:
permit or deny redemption of the monetary amount based on the determination of the generated TKC, the expiration time of the TKC, and receipt of an input security authenticator from a first ATM of the one or more ATMs to authenticate the generated TKC upon receiving a request from the first ATM to redeem the generated TKC; and
generate, responsive to permitting redemption of the generated TKC, a flag for the generated TKC in the generated TKC database indicating that the generated TKC has been redeemed, such that subsequent requests to redeem the generated TKC will be denied based on the presence of the flag.

2. The system of claim 1, wherein the TKC is valid for a predetermined time period.

3. The system of claim 1, wherein the TKC circuit is further structured to generate the TKC including the security authenticator associated with the user of the user device.

4. The system of claim 1, wherein the processing circuit is structured to transmit the TKC to the user device, wherein the TKC is transmitted as a printable image that is presented to the user on a printed receipt.

5. The system of claim 1, wherein the processing circuit is structured to transmit the TKC to the user device in a form of at least one of a barcode or a QR code to be displayed on the user device of the user.

6. The system of claim 1, wherein the TKC circuit generates and transmits the TKC to a second POS computing system structured to interpret the TKC for the redemption of the monetary amount associated with the TKC.

7. The system of claim 6, wherein a reward bonus is added to the monetary amount for the redemption of the TKC with an owner of the user device.

8. A computer-implemented method, comprising:
receiving, by a provider computing system, a request to generate a tokenized cash code (TKC) from a point of sale (POS) system, the request indicating a monetary amount and a user device of a user;
generating, by the provider computing system, the tokenized cash code (TKC) associated with the monetary amount, wherein the TKC associated with the monetary amount is structured for redemption of the monetary amount at a retailer POS system or an automated teller machine (ATM), the TKC associated with an expiration time;;
determining, by the provider computing system, an authentication method based on the monetary amount and based on authorization preferences of the user;
transmitting, by the provider computing system, the TKC to the user device of the user indicated in the request, wherein the provider computing system receives a security authenticator from the user device to authenticate the TKC according to the determined authentication method;
presenting, by the user device via a display, a graphical user interface comprising a printable receipt generated by the POS system, the printable receipt indicating a corresponding transaction at the POS system, an identifier of the TKC, and the expiration time of the TKC, the graphical user interface further comprising a selectable option that, when selected, causes the user device to be directed to a provider website of a provider of the TKC configured to identify, based on location information of the user device, one or more automated teller machines (ATMs) capable of redeeming the TKC
receiving, by the provider computing system, a redemption request signal from a first ATM of the one or more ATMs indicating a request to redeem the TKC and utilize the security authenticator to authenticate the TKC according to the determined authentication method from the user device;
verifying, by the provider computing system, a validity of the TKC using the security authenticator and the expiration time of the TKC;
transmitting, by the provider computing system, an approval signal allowing for redemption of the TKC; and
generating, by the provider computing system, responsive to verifying the validity of the TKC, a flag for the TKC in a TKC database indicating that the TKC has been redeemed, such that subsequent requests to redeem the TKC will be denied based on the presence of the flag.

9. The method of claim 8, further comprising generating a valid time period associated with the TKC, wherein the valid time period defines a time period for which the TKC can be redeemed.

10. The method of claim 8, wherein generating the TKC involves generating the security authenticator associated with the TKC, wherein the security authenticator is structured to authenticate the user of the user device.

11. (canceled)

12. The method of claim 8, wherein the method further includes printing, by the POS system, a receipt with the TKC as a printed image on the receipt.

13. The method of claim 8, wherein generating the TKC associated with the monetary amount further includes adding a reward bonus to the monetary amount for the redemption of the TKC.

14. A system, comprising:
a user device of a user, the user device configured to:
present a graphical user interface comprising a printable receipt generated by a point of sale (POS) system, the printable receipt indicating a corresponding transaction at the POS system, an identifier of a tokenized cash code (TKC), and an expiration time of the TKC, the graphical user interface further comprising a selectable option that, when selected, causes the user device to be directed to a provider website of a provider of the TKC configured to identify, based on location information of the user device, one or more automated teller machines (ATMs) capable of redeeming the TKC;
a first ATM of the one or more ATMs comprising a network interface and a processing circuit, the network interface structured to facilitate data communication via a network, and the processing circuit comprising a processor and memory, the memory storing instructions thereon that, when executed by the processor, cause the processing circuit to perform operations comprising:
receiving an input from the user device comprising the TKC associated with the expiration time; and
interpreting the TKC to determine a monetary amount associated with the TKC and the user device of the user for which the TKC was generated;
selecting an authentication method based on the monetary amount, the authentication method selected based on the monetary amount associated with the TKC and based on authorization preferences of the user;
receiving a security authenticator from the user device of the user to authenticate the TKC according to the determined authentication method;
determining that the security authenticator does not authorize redemption of the TKC;
responsive to determining that the security authenticator does not authorize redemption of the TKC, prompting the user to provide a second security authenticator to authenticate the TKC, the second security authenticator corresponding to a second authentication method;
redeeming the monetary amount associated with the TKC based on authenticating the TKC using the second security authenticator received from the user device at the time of redemption; and
transmitting, to a provider computing system associated with the TKC, a signal indicating that the TKC has been redeemed using the user device, the signal causing the provider computing system to generate a flag for the TKC in a TKC database indicating that the TKC has been redeemed, such that subsequent requests to redeem the TKC will be denied based on the presence of the flag.

15. The system of claim 14, further comprising at least one of:
a scanner structured to scan a code associated with the TKC; or
a keypad structured to facilitate manual input of the TKC.

16. The system of claim 15, wherein the operations further comprise comparing the security authenticator to a reference authenticator to facilitate authorization of the user.

17. The system of claim 14, wherein the operations further comprise communicating with the provider computing system via the network interface, wherein the provider computing system is structured to verify the TKC.

18. The system of claim 17, wherein the operations further comprise dispensing the monetary amount associated with the TKC upon verification, by the provider computing system, of the TKC.

19. The system of claim 14, further comprising a display structured to present information to the user, wherein the information presented on the display is based on the TKC.

20. The system of claim 19, wherein the information presented via the display comprises one or more redemption options, wherein the one or more redemption options include at least one of:
a cash redemption option; or
a retailer credit option.
